(19) United States
(12) Patent Application Publication
(10) Pub. No.: US 2017/0264426 A1
(43) Pub. Date: Sep. 14, 2017

(54) METHOD AND APPARATUS FOR GENERATING SHORTER SIGNATURES ALMOST TIGHTLY RELATED TO STANDARD ASSUMPTIONS

(71) Applicant: THOMSON LICENSING, Issy les Moulineaux (FR)

(72) Inventors: Marc JOYE, Palo Alto, CA (US); Benoit LIBERT, Lyon (FR)

(73) Assignee: Thomson Licensing, Issy les Moulineaux (FR)

(21) Appl. No.: 15/310,268

(22) PCT Filed: May 11, 2015
(86) PCT No.: PCT/US2015/030065

§ 371 Date: Nov. 10, 2016

Related U.S. Application Data
(60) Provisional application No. 61/994,208, filed on May 16, 2014.
(60) Provisional application No. 62/093,075, filed on Dec. 17, 2014.

(51) Int. Cl. H04L 9/00; H04L 9/32; H04L 9/30

(52) U.S. Cl. CPC H04L 9/008; H04L 9/3073; H04L 9/3247

(57) ABSTRACT

The present principles use the message to be signed as a label—of the private key augmented with a QA-NIZK proof that the encrypted value is a persistent hidden secret. One-time homomorphic signatures are used to generate the signature and the public key. The private key for the one-time homomorphic signatures is included in the private key for signing the message, and the public key for the one-time homomorphic signatures is included in the public key for verifying the signature. Consequently, we obtain DLIN-based signatures comprised of only 6 group elements. The security proof uses a sequence of hybrid games, gradually moves to a game where all signatures contain an encryption of a random value while the QA-NIZK proofs are simulated proofs for false statements.

### CROSS-REFERENCE TO RELATED APPLICATIONS

This application claims the benefit of the filing date of the following U.S. Provisional Application, which is hereby incorporated by reference in its entirety: Ser. No. 61/994,208, filed on May 16, 2014, and titled “Shorter Signatures Almost Tightly Related to Standard Assumptions.”

### TECHNICAL FIELD

This invention relates to a method and an apparatus for cryptography, and more specifically, to a method and an apparatus for generating efficient digital signatures with security proofs in the standard model.

### BACKGROUND

A cryptosystem is said tightly secure when, in the security proof, a successful adversary is turned into an algorithm—with comparable running time—breaking the underlying number theoretic assumption with nearly the same probability as the adversary's advantage. Namely, if the adversary has advantage ε, the reduction should succeed with probability at least ε/c, where c is a small constant. So far, relatively few digital signature schemes have a tight security proof in the standard model (i.e., without using the random oracle model) and existing ones tend to rely on relatively strong and non-standard assumptions.

In 2013, J. Chen and H. Wee, in an article entitled “Fully, (Almost) Tightly Secure IBE and Dual System Groups,” in Crypto '13, LNCS 8043, pp. 435-460, 2013 (hereinafter “Chen”), described signature schemes whose security can be almost tightly related to standard assumptions. Here, “almost tightly” means that, if the adversary has advantage ε, the reduction's probability of success is at least ε/(c·λ), where λ is the security parameter and c is a constant. As a result, the security bound is only affected by the security parameter, and not by the number of signatures observed by the adversary.

The security of public-key cryptographic primitives is usually established by demonstrating that any successful probabilistic polynomial time (PPT) adversary [symbol] implies a PPT algorithm [symbol] solving a hard problem. In order to be convincing, such “reductionist” arguments should be as tight as possible. Ideally, algorithm [symbol] 's probability of success should be about as large as the adversary's advantage. The results of M. Bellare and P. Rogaway, as described in an article entitled “The Exact Security of Digital Signatures—How to Sign with RSA and Rabin,” in Eurocrypt '96, LNCS 1070, pp. 399-416, 1996, initiated an important body of work devoted to the design of primitives validated by tight security reductions in the random oracle model and in the standard model. So far, all signature schemes with tight security proofs in the standard model rely on strong and non-standard assumptions like the Strong RSA assumption or the Strong Diffie-Hellman assumption. No signature scheme is known to have a tight reduction in the standard model under the standard Diffie-Hellman assumption or the RSA assumption, for example. While there exist efficient signature schemes based on the Diffie-Hellman and RSA assumptions, their reductions all lose a factor of q with respect to the adversary's advantage, where q is the number of signature queries made by the adversary.

Tight security proofs may be hard to achieve and are even known not to exist at all in some situations. On the positive side, long-standing open problems have been resolved in the recent years. D. Hofheinz and T. Jager, in an article entitled “Tightly Secure Signatures and Public-Key Encryption,” in Crypto '12, LNCS 7417, pp. 590-607, 2012, showed the first public-key encryption scheme whose chosen-ciphertext security in the multi-user setting tightly relates to a standard hardness assumption. The Chen reference answered an important open question raised in an article, by B. Waters, entitled “Efficient Identity-Based Encryption Without Random Oracles,” in Eurocrypt '05, LNCS 3494, 2005, by avoiding the concrete security loss, proportional to the number of adversarial queries, that affected the security reductions of all previous identity-based encryption (IBE) schemes based on simple assumptions, including those based on the dual system paradigm. The results of the Chen reference also implied the shortest signatures almost tightly related to standard assumptions in the standard model. In the terminology of the Chen reference, “almost tight security” refers to reductions where the degradation factor only depends on the security parameter λ, and not on the number q of adversarial queries which is potentially much larger. Indeed, it is common to assume λ=128 and q≈2³⁰.

While the results of the Chen reference achieved a significant improvement by avoiding any dependency on the number q of adversarial queries in their security bound, their schemes feature longer signatures than existing signature schemes with loose reductions under standard assumptions. Here, “loose reduction” means that the reduction is affected by a multiplicative factor Ω(q), where q is the number of signatures obtained by the adversary before outputting a signature forgery.

Definitions for Linearly Homomorphic Structure-Preserving Signatures

Let ( [symbol] , [symbol] _{T}) be groups of prime order p such that a bilinear map e: [symbol] × [symbol] → [symbol] _{T} can be efficiently computed.

A signature scheme is structure-preserving if messages, signatures and public keys all live in the group [symbol] . In linearly homomorphic structure-preserving signatures, the message space [symbol] consists of pairs [symbol] := [symbol] × [symbol] ⁿ, for some nε [symbol] , where [symbol] is a tag space. Depending on the application, one may or may not want the tags to be group elements. In the present application, they can be arbitrary strings.

A linearly homomorphic structure-preserving signature (SPS) scheme over ( [symbol] , [symbol] _{T}) is a tuple of efficient algorithms Σ=(Keygen, Sign, Sign Derive, Verify) for which the message space consists of [symbol] := [symbol] × [symbol] ⁿ, for some integer nεpoly(λ) and some set [symbol] , and with the following specifications.

Keygen (λ, n): is a randomized algorithm that takes in a security parameter λε [symbol] and an integer nεpoly(λ) denoting the dimension of vectors to be signed, where poly(λ) means that t and n are polynomial in λ. It outputs a key pair (pk, sk), where pk includes the description of a tag space [symbol] , where each tag serves as a file identifier.

Sign (sk, τ, \vec{M}): is a possibly randomized algorithm that takes as input a private key sk, a file identifier τε [symbol] and a vector \vec{M}=(M₁, . . . , Mₙ)ε [symbol] ⁿ. It outputs a signature σε [symbol] ⁿ^{ₛ}, for some nₛεpoly(λ).

Sign Derive(pk, τ, {(ωᵢ, σ⁽ⁱ⁾)}ᵢ₌₁^{l}): is a derivation algorithm, possibly randomized. It inputs a public key pk, a file identifier τ as well as l pairs (ωᵢ, σ⁽ⁱ⁾), each of which consists of a coefficient ωᵢε [symbol] ₚ and a signature σ⁽ⁱ⁾ε [symbol] ⁿ^{ₛ}. It outputs a signature σε [symbol] ⁿ^{ₛ} on the vector \vec{M}=Πᵢ₌₁^{l}\vec{M}ᵢ^{ω}^{ᵢ}, where σ⁽ⁱ⁾ is a signature on \vec{M}ᵢ.

Verify(pk, τ, \vec{M}, σ): is a deterministic verification algorithm that takes as input a public key pk, a file identifier τε [symbol] , a signature σ and a vector \vec{M}=(M₁, . . . , Mₙ). It outputs 0 or 1 depending on whether a is deemed valid or not.

In a one-time linearly homomorphic SPS, the tag τ can be omitted in the specification as a given key pair (pk, sk) only allows signing one linear subspace.

As in all linearly homomorphic signatures, the security requirement is that the adversary be unable to create a valid triple (τ*, \vec{M}*, σ*) for a new file identifier τ* or for a vector \vec{M}* outside the linear span of the vectors that have been legitimately signed for the tag τ*.

Hardness Assumptions

We use bilinear maps e: [symbol] × [symbol] → [symbol] _{T} over groups ( [symbol] , [symbol] , [symbol] _{T}) of prime order p. In some cases, we will assume that [symbol] ≠ [symbol] and that no efficiently computable isomorphism Ψ: [symbol] → [symbol] or Ψ: [symbol] → [symbol] is available.

Definition 1 The Decision Linear Problem (DLIN) in G, is to distinguish the distributions (g^{a}, g^{b}, g^{ac}, g^{bd}, g^{c+d}) and (g^{a}, g^{b}, g^{ac}, g^{bd}, g^{z}), with a, b, c, d [symbol] ₚ, z [symbol] ₚ, wherein “ [symbol] ” indicates a probabilistic process. The Decision Linear Assumption is the intractability of DLIN for any PPT distinguisher [symbol] .

The DLIN problem can be seen as the problem of deciding whether three vectors (g^{a}, [symbol] , g), ( [symbol] , g^{b}, g), (g^{ab}, g^{cd}, g^{z}) form a subspace of dimension two (which is the case when z=c+d) or three.

The DLIN problem can be generalized to higher dimensions than three.

Definition 2 The K-Linear Problem (K-LIN) in [symbol] , is to distinguish the distributions

D₁={(g₁, . . . ,g_{K},g,g₁^{a}^{₁}, . . . ,g_{K}^{a}^{_{K}},g^{Σ}^{ⱼ₌₁}^{^{K}}^{α}^{ⱼ})ε [symbol] ^{2K+2}|g₁, . . . ,g_{K},g [symbol] ,α₁, . . . ,α_{K} [symbol] p}

and

D₂={(g₁, . . . ,g_{K},g,g₁^{α}^{₁}, . . . ,g_{K}^{α}^{_{K}},g_{z})ε [symbol] ^{2K+2}|g₁, . . . ,g_{K},g [symbol] ,α₁, . . . ,α_{K},z [symbol] }

For each K≧2, the K-linear problem is known to remain generically hard even in the presence of an oracle that solves the (K−1)-linear problem.

For K=2, the K-linear assumption is exactly the DLIN assumption. For K=1, the assumption is equivalent to the Decision Diffie-Hellman assumption which says that the distributions {(g^{a}, g^{b}, g^{ab})|a, b [symbol] ₚ} and {(g, g^{a}, g^{b}, g^{c})|a, b, c [symbol] ₚ}, are computationally indistinguishable. It is possible to rely on this assumption in asymmetric bilinear groups ( [symbol] , [symbol] , [symbol] _{T}) (i.e., where [symbol] ≠ [symbol] ). When no isomorphism is efficiently computable between [symbol] and [symbol] in either direction, the DDH assumption can hold in both [symbol] and [symbol] . The hardness of DDH in both [symbol] and [symbol] is called Symmetric eXternal Diffie-Hellman assumption (SXDH). Importantly, the use of SXDH requires asymmetric pairings since DDH is easy when [symbol] = [symbol] .

When K>1, the K-linear assumption is believed to hold even in pairing-friendly groups where [symbol] = [symbol] .

Linearly Homomorphic Structure-Preserving Signatures

Linearly homomorphic SPS (LHSPS) schemes are homomorphic signatures where messages and signatures live in the domain group G of a bilinear map. A recent article, by B. Libert, T. Peters, M. Joye, and M. Yung, entitled “Linearly Homomorphic Structure-Preserving Signatures and their Applications,” in Crypto 2013, LNCS 8043, pp. 289-307, 2013 (hereinafter “Libert”), described the following one-time construction and proved its security under the SDP assumption.

Keygen (λ, n): given a security parameter λ and the dimension nε [symbol] of the subspace to be signed, choose bilinear group ( [symbol] , [symbol] , [symbol] _{T}) of prime order p>2^{λ}. Then, choose [symbol] , [symbol] , [symbol] , [symbol] . For i=1 to n, choose χᵢ, γᵢ, δᵢ [symbol] ₚ and compute [symbol] = [symbol] , [symbol] = [symbol] . The private key is sk={(χᵢ, γᵢ, δᵢ)}ᵢ₌₁ⁿ while the public key consists of pk=( [symbol] , [symbol] , [symbol] , [symbol] , { [symbol] , [symbol] )}ᵢ₌₁ⁿ)ε [symbol] ²ⁿ⁺⁴.

Sign (sk, (M₁, . . . , Mₙ)): to sign a vector (M₁, . . . , Mₙ)ε [symbol] ⁿ using sk={(χᵢ, γᵢ, δᵢ)}ᵢ₌₁ⁿ, output σ=(z,r,u)ε [symbol] ³, where z=Πᵢ₌₁ⁿMᵢ^{-χi}, r=Πᵢ₌₁ⁿ, Mᵢ^{-γi} and u=Πᵢ₌₁ⁿMᵢ^{-δi}.

Sign Derive(pk, {(ωᵢ, σ⁽ⁱ⁾)}ᵢ₌₁^{l}): given the public key pk as well as 2 tuples (ωᵢ, σ⁽ⁱ⁾), parse σ⁽ⁱ⁾ as σ⁽ⁱ⁾=(z₁,rᵢ,uᵢ)ε [symbol] ³ for i=1 to l. Compute and return σ=(z,r,u), where z=Πᵢ₌₁^{l}zᵢ^{ω}^{ᵢ}, r=Πᵢ₌₁^{l}rᵢ^{ω}^{ᵢ}, u=Πᵢ₌₁^{l}uᵢ^{ω}^{ᵢ}.

Verify(pk, σ(M₁, . . . , Mₙ)): given a signature σ=(z, r, u)ε [symbol] ³ and a vector (M₁, . . . , Mₙ), return 1 if and only if (M₁, . . . , Mₙ)≠( [symbol] , . . . , [symbol] ) and (z, r, u) satisfy

$${T}_{} = e ( z , ) \cdot e ( r , ) \cdot {\prod }_{i = 1} e ( {M}_{i} , {\hat{g}}_{i} ) , \\ {T}_{} = e ( z , ) \cdot e ( u , ) \cdot {\prod }_{i = 1}^{n} e ( {M}_{i} , {\hat{h}}_{i} ) . \qquad ( 1 )$$

The security of the above scheme was proved under an assumption which is implied by DLIN.

Under the k-linear assumption, the one-time linearly homomorphic structure-preserving signature of the Libert reference can be extended as follows.

Keygen (λ, n): given a security parameter λ and the dimension nε [symbol] of vectors to be signed, choose bilinear group ( [symbol] , [symbol] , [symbol] _{T}) of prime order p>2^{λ}. For j=1 to K, choose generators ĝ_{j,z}, ĝ_{j,r} [symbol] . Then, for each i=1 to n, j=1 to K, choose Xᵢ [symbol] ₚ, γ_{j,i} [symbol] ₚ and compute ĝ_{j,i}=g_{j,z}^{χi}ĝ_{j,r}^{γj,i}. The private key is sk=({χᵢ, {γ_{j,i}}ⱼ₌₁^{K}}ᵢ₌₁ⁿ) while the public key is pk=

Sign (sk, (M₁, . . . , Mₙ)): to sign (M₁, . . . , Mₙ)ε [symbol] ⁿ using sk=({χᵢ, {γ_{j,i}}ⱼ₌₁^{K}}ᵢ₌₁ⁿ), compute and output σ=(z, r₁, . . . , r_{K})ε [symbol] ^{K+1}, where

$$z = {\prod }_{i = 1}^{n} {M}_{i}^{- {χ}_{i}} , \\ {r}_{j} = {\prod }_{i = 1}^{n} {M}_{i}^{- {γ}_{j , i}} j ∈ \{ 1 , … , K \} .$$

SignDerive(pk, {(ωᵢ, σ⁽ⁱ⁾)}ᵢ₌₁^{l}): given a public key pk and l tuples (ωᵢ, σ⁽ⁱ⁾), where ωᵢε [symbol] ₚ for each i, parse σ⁽ⁱ⁾ as σ⁽ⁱ⁾=(zᵢ, r_{i,1}, . . . , r_{i,K})ε [symbol] ^{k+1} for i=1 to l. Then, compute and return σ=(z, r₁, . . . , rₖ), where z=Πᵢ₌₁^{l}zᵢ^{ω}^{ᵢ}, rⱼ=Πᵢ₌₁^{l}r_{i,j}^{ω}^{ᵢ} for j=1 to K.

Verify(pk, σ, (M₁, . . . , Mₘ)): given σ=(z, r₁, . . . , r_{K})ε [symbol] ^{K+1} and (M₁, . . . , Mₙ) return 1 if and only if (M₁, . . . , Mₙ)≠( [symbol] , . . . , [symbol] ) and, for each jε{1, . . . , K}, the following equality holds:

$${T}_{} = e ( z , {\hat{g}}_{j , z} ) \cdot e ( {r}_{j} , {\hat{g}}_{j , r} ) \cdot {\prod }_{i = 1}^{n} e ( {M}_{i} , {\hat{g}}_{j , i} ) . \qquad ( 2 )$$

Quasi-Adaptive NIZK Proofs

Let R be a relation that takes as input a statement w and a witness x such that R(x,w)=1 if and only if w belongs to a language [symbol] . We consider languages [symbol] where it may be hard to distinguish random elements of [symbol] from elements outside [symbol] . For example, consider an abelian group [symbol] of prime order p where the discrete logarithm problem is hard. If Aε [symbol] ₚ^{t×n} is a matrix or rank t<n, deciding the membership in a linear subspace g^{A}ε [symbol] ^{t×n} is believed to be hard for carefully chosen groups: in other words, the language [symbol] ={\vec{ν}ε [symbol] ⁿ|∃\vec{x}ε [symbol] ₚ^{t} s.t. \vec{ν}=g^{\vec{x}·A}} is hard to recognize. For such languages, proving the membership of a candidate wε [symbol] is non-trivial. Whenever wε [symbol] , any element x such that R(x,w)=1 is called a witness for the membership of w in [symbol] .

A non-interactive zero-knowledge (NIZK) proof for a relation R usually consists of three algorithms (K, P, V), where K is a randomized algorithm that takes as input a security parameter λε [symbol] and outputs a common reference string (CRS) ψ; P is a randomized algorithm used by the prover on input of a statement w and a witness x such that R(x,w)=1 to generate a proof π for the statement wε [symbol] ; algorithm V is a deterministic algorithm run by the verifier to output a binary value (which is 1 if and only if the verifier is convinced that wε [symbol] ) on input of the CRS ψ, a statement w and a proof π. The CRS ψ should be seen as a set of common public parameters generated by some trusted party. The zero-knowledge property usually refers to the existence of a simulator S that takes as input a true statement wε [symbol] but no witness. Instead of a witness, the simulator S uses a trapdoor τₛᵢₘ associated with the CRS to generate simulated proofs π whose distribution is statistically indistinguishable from real proofs π generated using the actual algorithm P. The intuition is that a proof π leaks nothing beyond the validity of the statement wε [symbol] .

Quasi-Adaptive NIZK (QA-NIZK) proofs are NIZK proofs where the CRS is allowed to depend on the specific language for which proofs have to be generated. The CRS is divided into a fixed part Γ, produced by an algorithm K₀, and a language-dependent part ψ. However, there should be a single simulator for the entire class of languages.

Let λε [symbol] be a security parameter. For public parameters Γ produced by K₀, let [symbol] _{Γ} be a probability distribution over a collection of relations [symbol] ={R_{ρ}} parameterized by a string ρ with an associated language [symbol] _{ρ}={x|∃w:R_{ρ} (x, w)=1}.

We consider proof systems where the prover and the verifier both take a label |b| as additional input. For example, this label can be the message-carrying part of an Elgamal-like encryption. Formally, a tuple of algorithms (K₀, K₁, P, V) is a QA-NIZK proof system for [symbol] if there exists a PPT simulator (S₁, S₂) such that, for any PPT adversaries [symbol] ₁, [symbol] ₂ and [symbol] ₃, we have the properties hereunder.

Informally, quasi-adaptive completenes means that honestly generated proofs are always accepted by the verifier. Quasi-adaptive soundness captures that it should be computationally infeasible for the prover to trick the verifier into accepting a proof for a false statement. As for the quasi-adaptive zero-knowledge property, it requires the existence of a simulator (S₁, S₂) that can emulate the behavior of the real prover P (which always generates proofs using the witnesses) without knowing the witnesses x: instead, (S₁, S₂) uses a simulation trapdoor τₛᵢₘ hidden in the CRS ψ to create simulated proofs.

Quasi-Adaptive Completeness:

Pr[Γ←K₀(λ);ρ←D_{Γ};ψ←K₁(Γ,ρ);(x,w,|b|)← [symbol] ₁(Γ,ψ,ρ);π←P(ψ,x,w,|b|):V(ψ,x,π,|b|)=1 if R_{ρ}(x,w)=1]=1.

Quasi-Adaptive Soundness:

Pr[ΓK₀(λ);ρ←D_{Γ};ψ←K₁(Γ,φ;(x,π,|b|)← [symbol] ₂(Γ,ψ,ρ):V(ψ,x,π,|b|)=1 [symbol] (∃w:R_{ρ}(x,w)=1)]εneg|(λ).

Quasi-Adaptive Zero-Knowledge:

Pr[Γ←K₀(λ);ρ←D_{Γ};ψ←K₁(μ,ρ): [symbol] ₃^{P(ψrr)}(Γ,ψ,ρ)=1]≈Pr[Γ←K₀(λ);ρ←D_{Γ};(ψ,τₛᵢₘ)←S₁(Γ,ρ): [symbol] ₃^{S}^{₂}^{(ψ,τ}^{ₛᵢₘᵣ₎}(Γ,ψ,ρ)=1],

where
P(ψ,.,.,.) emulates the actual prover and outputs a proof π on input of (x,w)εRₚ and |b|.
S₂(ψ,τₛᵢₘ,.,.) is an oracle that takes as input xε [symbol] ₚ (i.e., for which there exists w such that (x,w)εR_{ρ}) as well as a label |b|, and outputs a simulated proof it S₂(ψ,τₛᵢₘ,|b|).

We assume that the CRS ψ contains an encoding of ρ, which is thus available to V. The definition of Quasi-Adaptive Zero-Knowledge requires a single simulator for the entire family of relations [symbol] .

An article by B. Libert, T. Peters, M. Joye, and M. Yung, entitled “Non-Malleability from Malleability: Simulation-Sound Quasi-Adaptive NIZK Proofs and CCA2-Secure Encryption from Homomorphic Signatures,” in Eurocrypt 2014, LNCS 8441, pp. 514-532, 2014, Cryptology ePrint Archive: Report 2013/691, (hereinafter “Libert2”) showed that linearly homomorphic structure-preserving signatures can be used to construct constant-size QA-NIZK proofs showing that a vector of group elements belongs to a linear subspace. The idea is to have the language-dependent CRS ψ contain the verification key of a one-time LHSPS and signature of each basis vector of the considered subspace. In order to prove that a vector of group elements \vec{ν}ε [symbol] ⁿ belongs to a subspace g^{A}ε [symbol] ^{t×n} of dimension n and rank t<n, the prover can use the witness \vec{x}ε [symbol] ₚ^{t} satisfying the equality \vec{ν}=g^{\vec{x}·A} to derive a linearly homomorphic signature on the vector f) using the signatures included in the CRS. In order to break the soundness of the proof system and prove the membership of a vector \vec{ν} outside the row space of g^{A}ε [symbol] ^{t×n} the adversary would have to create a non-trivial homomorphic signature on \vec{ν}, as shown in the Libert2 reference. The resulting proof system also provides constant-size proofs, regardless of the dimensions of the subspace.

### SUMMARY

According to an embodiment of the present principles, a method for signing a message is presented, comprising: accessing a first private key and a first set of public key elements, the first set of public key elements including a first set of vectors based on elements of a bilinear group and a second set of vectors based on one-time linearly homomorphic signatures, wherein at least one of the first set of vectors and the second set of vectors is generated using a probabilistic process; determining a first portion of a signature responsive to the message, the first private key and the first set of vectors; determining a second portion of the signature responsive to the first private key and the one-time linearly homomorphic signatures; forming the signature responsive to the first portion and the second portion; and transmitting the signature through a communication channel as described below. According to another embodiment of the present principles, an apparatus for performing these steps is also presented.

According to an embodiment of the present principles, a method for verifying a signature of a message is presented, comprising: accessing the message, the signature, and a first set of public key elements, the first set of public key elements including a first set of vectors based on elements of a bilinear group and a second set of vectors based on one-time linearly homomorphic signatures, wherein at least one of the first set of vectors and the second set of vectors is generated using a probabilistic process, wherein a first portion of the signature is determined responsive to the message, the first private key and the first set of vectors, and wherein a second portion of the signature is determined responsive to the first private key and the one-time linearly homomorphic signatures; and verifying whether the signature is valid responsive to the first set of public key elements and the message as described below. According to another embodiment of the present principles, an apparatus for performing these steps is also presented.

According to an embodiment of the present principles, a computer readable storage medium having stored thereon instructions for signing a message or verifying a signature of a message according to the methods described above is presented.

### BRIEF DESCRIPTION OF THE DRAWINGS

FIG. 1 is a flow diagram depicting an exemplary cryptographic method, in accordance with an embodiment of the present principles.

FIG. 2 is a block diagram depicting an exemplary cryptosystem, in accordance with an embodiment of the present principles.

FIG. 3 illustrates a block diagram of an exemplary system in which various aspects of the exemplary embodiments of the present principles may be implemented.

### DETAILED DESCRIPTION

The present embodiments devise signature schemes that provide shorter signatures than the Chen-Wee schemes as described in the Chen reference while retaining almost tight security under the same assumptions. Under the DLIN assumption, we would like to reduce the signature length from 8 to 6 groups elements. Under the K-linear assumption (which is believed weaker than DLIN when K>2), we want to reduce the signature length of the Chen-Wee scheme from 4K to 2K+2. Under the SXDH assumption, we aim for signatures made of 3 group elements (vs. 4 in the Chen reference).

TABLE 1 summarizes some abbreviations used in the present application.

TABLE 1

| | |
|---|---|
| PPT | Probabilistic Polynomial Time |
| CRS | Common Reference String |
| NIZK | Non-Interactive Zero-Knowledge |
| QA-NIZK | Quasi-Adaptive Non-Interactive Zero-Knowledge |
| DLIN | Decision Linear |
| k-linear | k-Linear |
| DDH | Decision Diffie-Hellman |
| SXDH | Symmetric eXternal Diffie-Hellman |
| GS | Groth-Sahai |
| IND-CCA | Indistinguishability under Chosen Plaintext Attacks |
| SPS | Structure-Preserving Signature |
| LHSPS | Linearly Homomorphic SPS |
| SDP | Simultaneous Double Pairing |
| IBE | Identity-Based Encryption |

Our schemes build on ideas used in a signature scheme described in an article by C. Jutla and A. Roy, entitled “Shorter Quasi-Adaptive NIZK Proofs for Linear Subspaces,” in Asiacrypt '13, LNCS 8269, pp. 1-20, 2013, Cryptology ePrint Archive: Report 2013/109, 2013 (hereinafter “Jutla2”), where each signature is an IND-CCA2-secure encryption using the message to be signed as a label of the private key augmented with a QA-NIZK proof that the encrypted value is a persistent hidden secret. The security proof uses a sequence of hybrid games, gradually moves to a game where all signatures contain an encryption of a random value while the QA-NIZK proofs are simulated proofs for false statements. At each step of the transition, increasingly many signatures are generated without using the private key and the CCA2-security of the encryption scheme ensures that this should not affect the adversary's probability to output a signature that does encrypt the private key. In the security proof of the Jutla2 reference, the latter approach implies that: (i) The number of transitions is proportional to the number of signing queries; (ii) A CCA2-secure encryption scheme is needed since, at each transition, the reduction needs to decrypt the ciphertext contained in the forgery.

Here, our key observation is that, by using a QA-NIZK proof system where the proof length is independent of the dimensions of the considered linear subspace, the approach of the Jutla2 reference can be combined with the proof technique of the Chen reference so as to reduce the number of game transitions while retaining short signatures. In addition, the techniques of the Chen reference allow us to dispense with the need for a CCA2-secure encryption scheme and settle for a semantically secure one. In short, by guessing exactly one bit of the target message, the reduction can decrypt a Boneh-Boyen-Shacham ciphertext, described in an article by D. Boneh, X. Boyen, and H. Shacham, entitled “Short group signatures,” in Crypto '04, LNCS 3152, pp. 41-55, 2004, contained in the forgery while embedding a DLIN instance in outputs of signing queries. For L-bit messages, by applying the proof technique of the Chen reference and another article by M. Naor and O. Reingold, entitled “Number-theoretic Constructions of Efficient Pseudo-random Functions,” in FOCS '97, pp. 458-467, 1997, we need L game transitions to reach a game where each signature encrypts a random function of the message and is independent of the private key. As a result, we obtain DLIN-based signatures comprised of only 6 group elements.

### First Embodiment

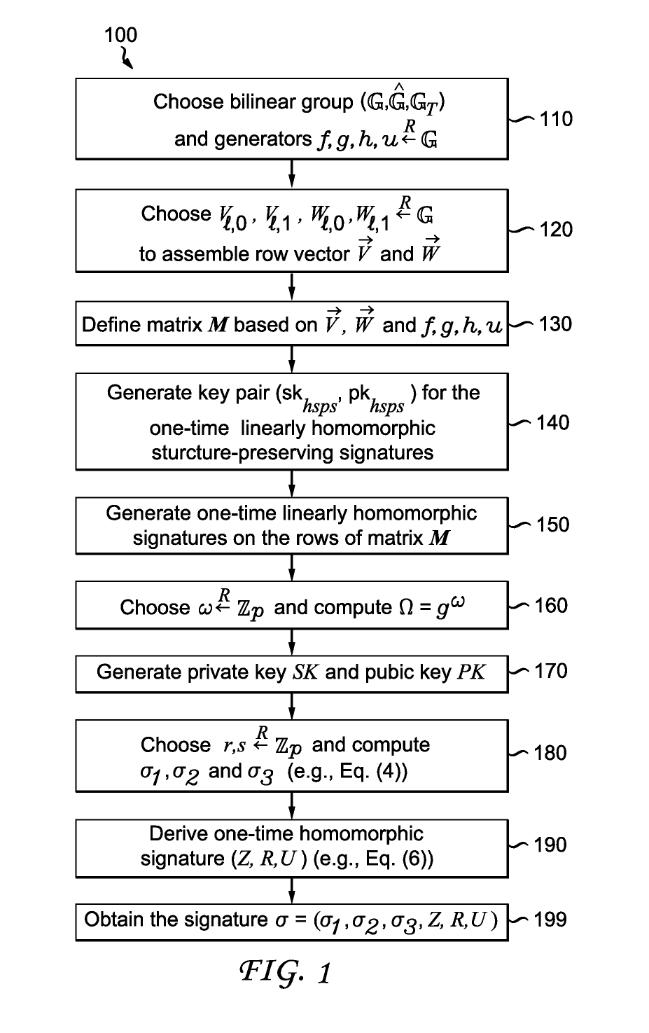

FIG. 1 illustrates an exemplary cryptographic method 100 according to an embodiment of the present principles. In particular, this embodiment relies on the Decision Linear assumption in asymmetric bilinear group.

Keygen(λ): At step 110, method 100 chooses bilinear groups ( [symbol] , [symbol] , [symbol] _{T}) of prime order p>2^{λ} together with generators f, g, h, u [symbol] .
1. At step 120, for l=1 to L, it chooses V_{l,0}, V_{l,1}, W_{l,0}, W_{l,1} [symbol] to assemble row vectors.

\vec{V}=(V_{1,0},V_{1,1}, . . . ,V_{L,0},V_{L,1})ε [symbol] ^{2L}

\vec{W}=(W_{1,0},W_{1,1}, . . . ,W_{L,0},W_{L,1})ε [symbol] ^{2L}.
2. At step 130, it defines the matrix

$$M = {( {M}_{i , j} )}_{i , j} ( \begin{matrix}{\vec{V}}^{T} & {Id}_{f , 2 L} & {1}^{2 L \times 2 L} & 1 \\ {\vec{W}}^{T} & {1}^{2 L \times 2 L} & {Id}_{h , 2 L} & 1 \\ u & {1}^{1 \times 2 L} & {1}^{1 \times 2 L} & g\end{matrix} ) ∈ {( 4 L + 1 ) \times ( 4 L + 2 )}^{} \qquad ( 3 )$$

with Id_{f,2L}=f^{I}^{_{2L}}ε [symbol] ^{2L×2L}, Id_{h,2L}=h^{I}^{_{2L}}ε [symbol] ^{2L×2L}, where I_{2L}ε [symbol] ₚ^{2L×2L} is the identity matrix.
3. At step 140, it generates a key pair (skₕₛₚₛ, pkₕₛₚₛ) for the one-time linearly homomorphic structure-preserving signature in order to sign vectors of dimension n=4 L+2. Let skₕₛₚₛ={(χᵢ, γᵢ, δᵢ)}ᵢ₌₁^{4L+2} be the private key, of which the corresponding public key is pkₕₛₚₛ=( [symbol] , [symbol] , [symbol] , [symbol] , {( [symbol] , [symbol] )}ᵢ₌₁^{4L+2}).
4. At step 150, using skₕₛₚₛ={χᵢ, γᵢ, δᵢ}ᵢ₌₁^{4L+2}, it generates one-time linearly homomorphic signatures {(Zⱼ, Rⱼ, Uⱼ)}ⱼ₌₁^{4L+1} on the rows \vec{M}ⱼ=(M_{j,1}, . . . , M_{j,4L+2})ε [symbol] ^{4L+2} of M. These are obtained as

$$( {Z}_{j} , {R}_{j} , {U}_{j} ) = ( {\prod }_{i = 1}^{4 L + 2} {M}_{j , i}^{- {χ}_{i}} , {\prod }_{i = 1}^{4 L + 2} {M}_{j , i}^{- {γ}_{i}} , {\prod }_{i = 1}^{4 L + 2} {M}_{j , i}^{- {δ}_{i}} ) ∀ j ∈ \{ 1 , … , 4 L + 1 \} .$$

5. At step 160, it chooses ω [symbol] ₚ, where [symbol] ₚ is the set of integers between 0 and p−1, where p is a prime, and computes Ω=g^{ω}ε [symbol] .
At step 170, the private key is defined to be SK=(ω,{λᵢ, γᵢ, δᵢ}ᵢ₌₁^{4L+2}) and the public key is

PK=(f,g,h,u,Ω=g^{ω},\vec{V},\vec{W},pkₕₛₚₛ=( [symbol] , [symbol] , [symbol] , [symbol] { [symbol] , [symbol] )}ᵢ₌₁^{4L+2}),{(Zⱼ,Rⱼ,Uⱼ)}ⱼ₌₁^{4L+1}).

Sign(SK, M): Given a message M=M[1] . . . M[L]ε{0,1}^{L} and the private key SK=(ω, {χᵢ, γᵢ, δᵢ}ᵢ₌₁^{4L+2}),
1. At step 180, it chooses r, s [symbol] ₚ and compute

σ₁=u^{ω}·H(\vec{V},M)^{r}·H(\vec{W},M)^{s},σ₂=f^{r} σ₃=h^{s}, (4)
where H(\vec{V}, M)=Πₗ₌₁^{L} V_{l,M[l]} and H(\vec{W},M)=Πₗ₌₁^{L} W_{l,M[l]}.
2. At step 190, using {(Zⱼ, Rⱼ, Uⱼ)}ⱼ₌₁^{4L+1}, it derives a one-time homomorphic signature (Z, R, U) which will serve as a non-interactive argument showing that the vector

(σ₁,σ₂^{1-M[1]},σ₂^{M[1]}, . . . ,σ₂^{1-M[L]},σ₂^{M[L]},σ₃^{1-M[1]},σ₃^{M[1]}, . . . ,σ₃^{1-M[L]},Ω) (5)
is in the row space of M, which ensures that (σ₁, σ₂, σ₃) is of the form (4). Namely, compute

$$Z = {Z}_{4 L + 1}^{ω} \cdot {\prod }_{i = 1}^{L} ( {Z}_{2 i - \overline{M [ i ]}}^{r} \cdot {Z}_{2 L + 2 i - \overline{M [ i ]}}^{s} ) , \\ R = {R}_{4 L + 1}^{ω} \cdot {\prod }_{i = 1}^{L} ( {R}_{2 i - \overline{M [ i ]}}^{r} \cdot {R}_{2 L + 2 i - \overline{M [ i ]}}^{s} ) , \\ U = {U}_{4 L + 1}^{ω} \cdot {\prod }_{i = 1}^{L} ( {U}_{2 i - \overline{M [ i ]}}^{r} \cdot {U}_{2 L + 2 i - \overline{M [ i ]}}^{s} ) ) \qquad ( 6 )$$

At step 199, it returns the signature σ=(σ₁, σ₂, σ₃, Z, R, U)ε [symbol] ⁶.

Verify(PK, M, σ): Parse σ as (σ₁, σ₂, σ₃, Z, R, U)ε [symbol] ⁶ and return 1 if and only if

$$e ( Z , ) \cdot e ( R , ) = {e ( {σ}_{1} , {\hat{g}}_{1} )}^{- 1} \cdot {e ( {σ}_{2} , {\prod }_{i = 1}^{L} {\hat{g}}_{2 i + M [ i ]} )}^{- 1} \cdot {e ( {σ}_{3} , {\prod }_{i = 1}^{L} {\hat{g}}_{2 L + 2 i + M [ i ]} )}^{- 1} \cdot {e ( Ω , {\hat{g}}_{4 L + 2} )}^{- 1}$$

$$e ( Z , ) \cdot e ( U , ) = {e ( {σ}_{1} , {\hat{h}}_{1} )}^{- 1} \cdot {e ( {σ}_{2} , {\prod }_{i = 1}^{L} {\hat{h}}_{2 i + M [ i ]} )}^{- 1} \cdot {e ( {σ}_{3} , {\prod }_{i = 1}^{L} {\hat{h}}_{2 L + 2 i + M [ i ]} )}^{- 1} \cdot {e ( Ω , {\hat{g}}_{4 L + 2} )}^{- 1} .$$

Each signature consists of 6 elements of [symbol] , which is as short as Lewko's DLIN-based signatures (see an article by A. Lewko, entitled “Tools for Simulating Features of Composite Order Bilinear Groups in the Prime Order Setting,” in Eurocrypt 2012, 2012, Section 4.3) where the security proof incurs a security loss proportional to the number of signing queries. Under the same assumption, the Chen-Wee signatures of the Chen reference require 8 group elements. We thus shorten signatures by 25%. Under the K-Linear assumption, our improvement is more dramatic. We also note that, using randomized batch verification techniques, the two verification equations can be simultaneously verified by computing a product of 7 pairings where the Chen reference computes a product of 8 pairings.

Note that we can obtain another embodiment by having the signature components live in [symbol] while the public key components are in [symbol] . The scheme also works in symmetric bilinear groups, where [symbol] = [symbol] . However, the above configuration yields shorter signatures in asymmetric bilinear groups ( [symbol] , [symbol] , [symbol] _{T}).

From a security point of view, we can prove the following result.

Theorem 1. The scheme provides existential unforgeability under chosen-message attacks if the DUN assumption holds in [symbol] and [symbol] . For L-bit messages, for any adversary [symbol] , there exist DLIN distinguishers [symbol] and [symbol] in [symbol] and [symbol] such that Ad [symbol] (λ)≦Ad [symbol] (λ)+(2L+1)·Ad [symbol] (λ), and with running times t_{B}, t_{B′}≦t [symbol] +q·poly(λ,L).

### Second Embodiment

Our signature scheme of the first embodiment can be modified so as to rely on the K-linear assumption with K>2. The construction goes as follows.

Keygen (λ): Choose bilinear groups ( [symbol] , [symbol] , [symbol] _{T}) of prime order p>2^{λ} together with generators f₁, . . . , f_{K}, u₁, u_{K} [symbol] .
1. For j=1 to K and l=1 to L, choose V_{j,l,0}, V_{j,l,1} [symbol] to assemble row vectors \vec{V}ⱼ=(V_{j,1,0}, V_{j,1,1}, . . . , V_{j,L,0}, V_{j,L,1})ε [symbol] ^{2L} ∀jε{1, . . . , K}
2. Define Mε [symbol] ^{K(2L+1)×(K(2L+1)+1)} as the matrix

$${( {M}_{i , j} )}_{i , j} = ( \begin{matrix}{\vec{V}}_{1}^{T} & {Id}_{{f}_{1} , 2 L} & … & {1}^{2 L \times 2 L} & 1 & … & … & 1 \\ ⋮ & ⋱ & ⋱ & & ⋮ & ⋱ & & ⋮ \\ {\vec{V}}_{K}^{T} & {1}^{2 L \times 2 L} & … & {Id}_{{f}_{K} , 2 L} & 1 & & & ⋮ \\ g & {1}^{1 \times 2 L} & & {1}^{1 \times 2 L} & {u}_{1} & 1 & … & 1 \\ g & {1}^{1 \times 2 L} & & {1}^{1 \times 2 L} & 1 & {u}_{2} & & ⋮ \\ g & {1}^{1 \times 2 L} & & {1}^{1 \times 2 L} & ⋮ & … & ⋱ & ⋮ \\ g & {1}^{1 \times 2 L} & … & {1}^{1 \times 2 L} & 1 & … & & {u}_{K}\end{matrix} )$$

with Id_{f}_{ⱼ}_{,2L}=fⱼ^{I}^{_{2L}}ε [symbol] ^{2L×2L} for each jε{1, . . . , K}, where I_{2L}ε [symbol] ^{2L×2L} is the identity matrix.
3. Generate a key pair (skₕₛₚₛ, pkₕₛₚₛ) for the one-time homomorphic structure-preserving signature in order to sign vectors of dimension n=K(2L+1)+1. Let skₕₛₚₛ=({χᵢ, {γ_{j,i}}ⱼ₌₁^{K}}ᵢ₌₁^{K(2L+1)+1)}) be the private key, of which the corresponding public key is

pkₕₛₚₛ=({ĝ_{j,z},ĝ_{j,r},{ĝ_{j,i}}ᵢ₌₁ⁿ}ⱼ₌₁^{K(2L+1)+1)}).
4. Using skₕₛₚₛ, generate one-time homomorphic signatures {(Zᵢ, R_{i,1}, . . . , R_{i,K})}ᵢ₌₁^{K(2L+1)} on the rows \vec{M}ᵢ=M_{i,1}, . . . , M_{i,4L+2})ε [symbol] ^{K(2L+1)+1} of M.
5. Choose ω₁, . . . , ω_{K} [symbol] ₚ and compute Ωᵢ=uᵢ^{ω}^{ᵢ}ε [symbol] for i=1 to K. The private key consists of SK={(ω₁, . . . , ψ_{K}), skₕₛₚₛ} and the public key is

PK=({(fᵢ,uᵢ,Ωᵢ),\vec{V}ᵢ}ᵢ₌₁^{K},pkₕₛₚₛ,{(Zᵢ,R_{i,1}, . . . ,R_{i,K})}ᵢ₌₁^{K(2L+1)})

Sign(SK, M): In order to sign a message M=M[1] . . . M[L]ε{0,1}^{L} using the private key SK={(ω₁, . . . , ω_{K}), skₕₛₚₛ},
1. Choose r₁, . . . , r_{K} [symbol] ₚ and compute

σ₀=g^{Σ}^{ⱼ₌₁}^{ω}^{ⱼ}^{^{K}}·Πⱼ₌₁^{K}H(\vec{V}ⱼ,M)^{r}^{ⱼ},σⱼ=fᵢ^{r}^{ᵢ} ∀jε{1, . . . ,K}
where H(\vec{V}ⱼ,M)=Πₗ₌₁^{L} V_{j,l,M[l]} for each jε{1, . . . , K}.
2. Using {(Zᵢ, R_{i,1}, . . . , R_{i,K})}ᵢ₌₁^{K(2L+1)}, derive a one-time linearly homomorphic signature (Z, R₁, . . . , R_{K}) which will argue that the vector (σ₀, σ₁^{1-M[1]}, σ₁^{M[1]}, . . . , σ₁^{1-M[L]}, σ₁^{M[L]}, . . . , σ_{K}^{1-M[1]}, σ_{K}^{M[1]}, . . . , σ_{K}^{1-M[L]}, . . . , σ_{K}^{M[L]}, Ω₁, . . . , Ω_{K}) is in the row space of M, which argues that (σ₀, σ₁, . . . , σ_{K}) was generated as per step 1.
Return the signature σ=(σ₀, σ₁, . . . , σ_{K}, Z, R₁, . . . , R_{K})ε [symbol] ^{2K+2}.

Verify(PK, M, σ): Parse σ as (σ₀, σ₁, . . . , σ_{K}, Z, R₁, . . . , R_{K})ε [symbol] ^{2K+2} and return 1 if and only if the following equations hold for each jε{1, . . . , K}.

$$e ( Z , {\hat{g}}_{j , z} ) \cdot {\prod }_{j = 1}^{K} e ( {R}_{j} , {\hat{g}}_{j , r} ) = {e ( {σ}_{0} , {\hat{g}}_{1} )}^{- 1} \cdot {e ( {σ}_{1} , {\prod }_{i = 1}^{L} {\hat{g}}_{j , 2 i + M [ i ]} )}^{- 1} … {e ( {σ}_{K} , {\prod }_{i = 1}^{L} {\hat{g}}_{j , 2 ( K - 1 ) L + 2 i + M [ i ]} )}^{- 1} \cdot {\prod }_{i = 1}^{K} {e ( {Ω}_{i} , {\hat{g}}_{j , 2 KL + 1 + i} )}^{- 1}$$

The security proof is completely similar to that of our first embodiment. The only difference is that, in order to achieve a tight reduction in the last step, the above scheme relies on a computational analogue of the K-linear assumption instead of the Diffie-Hellman assumption. The reason is that, while the latter is not stronger than the K-linear assumption, we do not know how to solve a K-linear instance with only one call to a CDH oracle.

In each signature, we only need 2K+2 group elements instead of 4K in the Chen reference, which thus saves 2K−2 elements when K>1. As K increases, our signatures thus become almost 50% shorter than in the one described in the Chen reference.

Under the SXDH assumption, a direct instantiation of the above scheme entails 4 elements of G per signature, which is as long as the Chen reference. However, the QA-NIZK proof system as described in an article by C. Jutla and A. Roy, entitled “Switching Lemma for Bilinear Tests and Constant-size NIZK Proofs for Linear Subspaces,” in Cryptology ePrint Archive: Report 2013/670, 2013 (hereinafter “Jutla”), can supersede the one of the Libert2 reference since, under the SXDH assumption, it only requires one group element per proof, instead of two in the Libert2 reference. The signature thus becomes a triple (σ₁, σ₂, Z)=(u^{ω}·H(\vec{V},M)^{r}, f^{r}, Z), where Z is a QA-NIZK proof of well-formedness for (σ₁, σ₂), so that we only need 3 group elements per signature (instead of 4 in the Chen reference).

The reason why the proof system of the Jutla reference should be preferred under the SXDH assumption (i.e., when K=1) is the following. Under the K-linear assumption, the proof sizes of the Libert2 and Jutla references are K+1 and K², respectively. While the former is more efficient for K≧2, the construction of the Jutla reference is optimal when K=1. In the SXDH-based variant with shorter signatures, each signature consists of a pair (σ₁, σ₂)=(u^{ω}·H(\vec{V},M)^{r}, f^{r})ε [symbol] ² and a QA-NIZK proof Zε [symbol] that (σ₁, σ₂) has the correct form.

Advantageously, the present embodiments provide new signature schemes with almost tight security and shorter signatures.

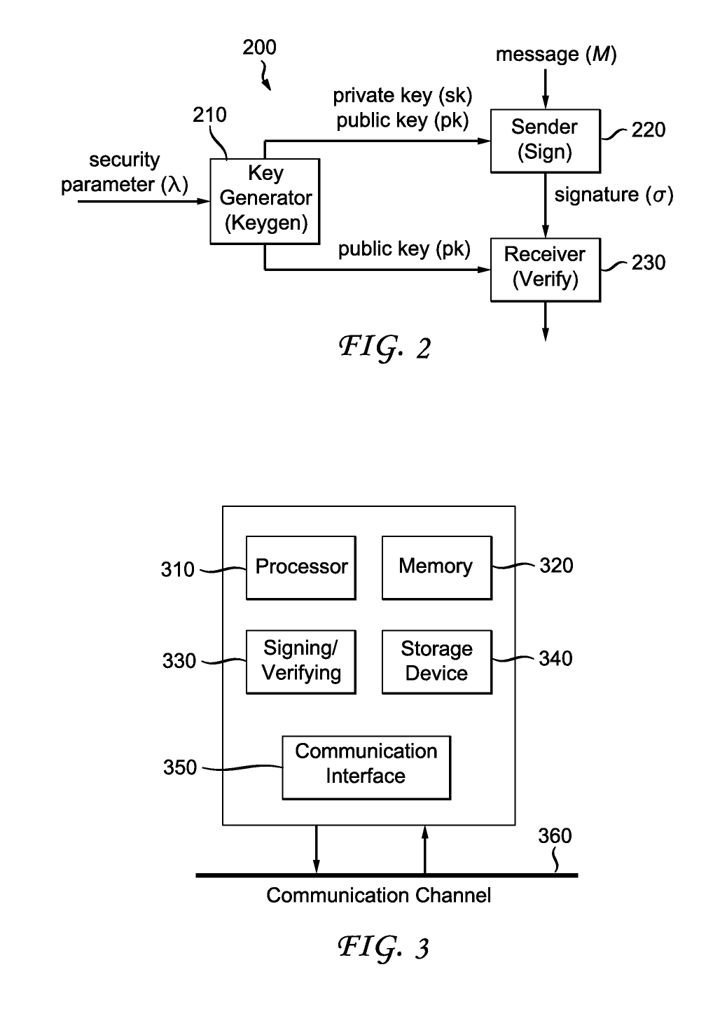

FIG. 2 depicts a block diagram of an exemplary cryptosystem, which includes key generator 210, sender 220 and receiver 230. Key generator 210 takes security parameter λ as input, and outputs a matching pair of public key (pk) and private key (sk) for some user. Sender 220 generates signature σ based on the private key, the public key, and message M. For signature σ, receiver 230 verifies whether the signature is valid or not.

Sender 220 in the cryptosystem may correspond to a device (for example, a computer, a tablet, a mobile phone), a software application, or a combination of both a hardware module and a software application, and receiver 230 may correspond to a different device or software application. Sender 220 may receive a message through input devices, for example, a keyboard, touchscreen or voice/video input. Sender 220 and receiver 230 may be connected through a network, for example, through Internet or mobile network. Key generator 210 can be located in the same device as or in a different device from sender 220.

FIG. 3 illustrates a block diagram of an exemplary system in which various aspects of the exemplary embodiments of the present principles may be implemented. System 300 may be embodied as a device including the various components described below and is configured to perform the processes described above. Examples of such devices, include, but are not limited to, personal computers, laptop computers, smartphones, tablet computers, digital multimedia set top boxes, digital television receivers, personal video recording systems, connected home appliances, and servers. System 300 may be communicatively coupled to other similar systems, and to trusted third parties via a communication channel and as known by those skilled in the art to implement the exemplary cryptosystems described above.

The system 300 may include at least one processor 310 configured to execute instructions loaded therein for implementing the various processes as discussed above. Processor 310 may include embedded memory, input output interface and various other circuitries as known in the art. The system 300 may also include at least one memory 320 (e.g., a volatile memory device, a non-volatile memory device). System 300 may additionally include a storage device 340, which may include non-volatile memory, including, but not limited to, EEPROM, ROM, PROM, RAM, DRAM, SRAM, flash, magnetic disk drive, and/or optical disk drive. The storage device 340 may comprise an internal storage device, an attached storage device and/or a network accessible storage device, as non-limiting examples. System 300 may also include a signing/verifying module 330 configured to process data to provide a signed message or to verify a signed message.

Signing/verifying module 330 represents the module(s) that may be included in a device to perform the signing and/or verifying functions. As is known, a device may include one or both of the signing or verifying modules, for example, verifying the signature on a message may be done on a regular PC since signature verification does not involve secret key so that the PC need not include secure memory for storing the encryption key. Signing messages however, requires secret keys (i.e., the private signing key) and is done in a secure device, for example a smart card. As memory is expensive on smart card, the signature verification functionality may not always be provided on a smart card. The signing and/or verification may be performed using shared resources as known to those skilled in the art. Additionally, signing/verifying module 330 may be implemented as a separate element of system 300 or may be incorporated within processors 310 as a combination of hardware and software as known to those skilled in the art.

Program code to be loaded onto processors 310 to perform the various processes described hereinabove may be stored in storage device 340 and subsequently loaded onto memory 320 for execution by processors 310. In accordance with the exemplary embodiments of the present principles, one or more of the processor(s) 310, memory 320, storage device 340 and signing/verifying module 330 may store one or more of the various items during the performance of the processes discussed herein above, including, but not limited to a public key, a private key, signed messages, equations, formula, matrices, variables, operations, and operational logic.

The system 300 may also include communications interface 350 that enables communication with other devices via communication channel 360. The communication interface 350 may include, but is not limited to a transceiver configured to transmit and receive data from communication channel 360. The communication interface may include, but is not limited to, a modem or network card and the communication channel may be implemented within a wired and/or wireless medium. The various components of system 300 may be connected or communicatively coupled together using various suitable connections, including, but not limited to internal buses, wires, and printed circuit boards.

The implementations described herein may be implemented in, for example, a method or a process, an apparatus, a software program, a data stream, or a signal. Even if only discussed in the context of a single form of implementation (for example, discussed only as a method), the implementation of features discussed may also be implemented in other forms (for example, an apparatus or program). An apparatus may be implemented in, for example, appropriate hardware, software, and firmware. The methods may be implemented in, for example, an apparatus such as, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation” of the present principles, as well as other variations thereof, mean that a particular feature, structure, characteristic, and so forth described in connection with the embodiment is included in at least one embodiment of the present principles. Thus, the appearances of the phrase “in one embodiment” or “in an embodiment” or “in one implementation” or “in an implementation”, as well any other variations, appearing in various places throughout the specification are not necessarily all referring to the same embodiment.

Additionally, this application or its claims may refer to “determining” various pieces of information. Determining the information may include one or more of, for example, estimating the information, calculating the information, predicting the information, or retrieving the information from memory.

Further, this application or its claims may refer to “accessing” various pieces of information. Accessing the information may include one or more of, for example, receiving the information, retrieving the information (for example, from memory), storing the information, processing the information, transmitting the information, moving the information, copying the information, erasing the information, calculating the information, determining the information, predicting the information, or estimating the information.

Additionally, this application or its claims may refer to “receiving” various pieces of information. Receiving is, as with “accessing”, intended to be a broad term. Receiving the information may include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

As will be evident to one of skill in the art, implementations may produce a variety of signals formatted to carry information that may be, for example, stored or transmitted. The information may include, for example, instructions for performing a method, or data produced by one of the described implementations. For example, a signal may be formatted to carry the bitstream of a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

1. A method for signing a message, comprising:
accessing a first private key and a first set of public key elements, the first set of public key elements including a first set of vectors based on elements of a bilinear group and a second set of vectors based on one-time linearly homomorphic signatures, wherein at least one of the first set of vectors and the second set of vectors is generated using a probabilistic process;
determining a first portion of a signature responsive to the message, the first private key and the first set of vectors;
determining a second portion of the signature responsive to the first private key and the one-time linearly homomorphic signatures;
forming the signature responsive to the first portion and the second portion; and
transmitting the signature through a communication channel.

2. The method of claim 1, wherein the signature under a K-linear assumption consists of 2K+2 elements from the bilinear group, and wherein each of the first portion and the second portion of the signature corresponds to K+1 elements from the bilinear group.

3. The method of claim 2 wherein K=2.

4. The method of claim 1, wherein the determining a first portion of a signature comprising:
determining a first element of the first portion of the signature responsive to the message, the first private key and the first set of vectors; and
determining each of remaining elements of the first portion of the signature responsive to a respective generator included in the first set of public key elements.

5. The method of claim 4, wherein the first set of vectors are \vec{V}ⱼ=(V_{j,1,0}, V_{j,1,1}, . . . , V_{j,L,0}, V_{j,L,1})ε [symbol] ^{2L}, wherein [symbol] is the bilinear group and V_{j,l,0}, V_{j,l,1} [symbol] for j=1 to K and l=1 to L.

6. The method of claim 5, wherein the first element of the first portion of the signature is determined as σ₀=g^{Σ}^{ⱼ₌₁}^{ω}^{ⱼ}^{^{K}}·Πⱼ₌₁^{K}H(\vec{V}ⱼ,M)^{r}^{ⱼ}, wherein M=M[1] . . . M[L]ε{0,1}^{L} represents the message being signed, ω₁, . . . , ω_{K} are included in the first private key, rⱼ are random integers, and H(\vec{V}ⱼ,M)=Πₗ₌₁^{L} V_{j,l,M[l]} for each jε{1, . . . , K}.

7. The method of claim 5, wherein the one-time linearly homomorphic signatures are generated responsive to matrix
$${( {M}_{i , j} )}_{i , j} = ( \begin{matrix}{\vec{V}}_{1}^{T} & 1 {d}_{{f}_{1} , 2 L} & … & {1}^{2 L \times 2 L} & 1 & … & … & 1 \\ ⋮ & ⋱ & ⋱ & & ⋮ & ⋱ & & ⋮ \\ {\vec{V}}_{K}^{T} & {1}^{2 L \times 2 L} & … & 1 {d}_{{f}_{K} , 2 L} & 1 & & & ⋮ \\ g & {1}^{1 L \times 2 L} & & {1}^{2 L \times 2 L} & {u}_{1} & 1 & … & 1 \\ g & {1}^{1 L \times 2 L} & & {1}^{2 L \times 2 L} & 1 & {u}_{2} & & ⋮ \\ g & {1}^{1 L \times 2 L} & & {1}^{2 L \times 2 L} & ⋮ & … & ⋱ & ⋮ \\ g & {1}^{1 L \times 2 L} & … & {1}^{2 L \times 2 L} & 1 & … & & {u}_{K}\end{matrix} )$$
wherein Id_{f}_{ⱼ}_{,2L}=fⱼ^{I}^{_{2L}}ε [symbol] ^{2L×2L} and I_{2L} is an identity matrix in [symbol] ^{2L×2L}, p is the order of group [symbol] , and generators g, f₁, . . . , f_{K}, u₁, . . . , u_{K} [symbol] .

8. The method of claim 7, wherein the one-time linearly homomorphic signatures {(Zᵢ, R_{i,1}, . . . , R_{i,K})}ᵢ₌₁^{K(2L+1)} are determined on rows \vec{M}ᵢ=(M_{i,1}, . . . , M_{i,4L+2})ε [symbol] ^{K(2L+1)+1} of M=(M_{i,j})_{i,j}, using a private key skₕₛₚₛ=({χᵢ, {γ_{j,i}}ⱼ₌₁^{K}}ᵢ₌₁^{K(2L+1)+1)}, wherein χᵢ, γ_{j,i} [symbol] .

9. The method of claim 8, wherein the first private key includes the private key skₕₛₚₛ for the one-time linearly homomorphic signatures.

10. A method for verifying a signature of a message, comprising:
accessing the message, the signature, and a first set of public key elements, the first set of public key elements including a first set of vectors based on elements of a bilinear group and a second set of vectors based on one-time linearly homomorphic signatures, wherein at least one of the first set of vectors and the second set of vectors is generated using a probabilistic process,
wherein a first portion of the signature is determined responsive to the message, the first private key and the first set of vectors, and
wherein a second portion of the signature is determined responsive to the first private key and the one-time linearly homomorphic signatures; and
verifying whether the signature is valid responsive to the first set of public key elements and the message.

11. The method of claim 10, wherein the signature under a K-linear assumption consists of 2K+2 elements from the bilinear group, and wherein each of the first portion and the second portion of the signature corresponds to K+1 elements from the bilinear group.

12. The method of claim 11 wherein K=2.

13. An apparatus for signing a message, comprising:
an interface configured to access a first private key and a first set of public key elements, the first set of public key elements including a first set of vectors based on elements of a bilinear group and a second set of vectors based on one-time linearly homomorphic signatures, wherein at least one of the first set of vectors and the second set of vectors is generated using a probabilistic process; and
a processor configured to
determine a first portion of a signature responsive to the message, the first private key and the first set of vectors,
determine a second portion of the signature responsive to the first private key and the one-time linearly homomorphic signatures, and
form the signature responsive to the first portion and the second portion.

14. The apparatus of claim 13, wherein the signature under a K-linear assumption consists of 2K+2 elements from the bilinear group, and wherein each of the first portion and the second portion of the signature corresponds to K+1 elements from the bilinear group.

15. The apparatus of claim 14 wherein K=2.

16. The apparatus of claim 13, wherein the processor is configured to:
determine a first element of the first portion of the signature responsive to the message, the first private key and the first set of vectors; and
determine each of remaining elements of the first portion of the signature responsive to a respective generator included in the first set of public key elements.

17. The apparatus of claim 16, wherein the first set of vectors are \vec{V}ⱼ=(V_{j,1,0}, V_{j,1,1}, . . . , V_{j,L,0}, V_{j,L,1})ε [symbol] ^{2L}, wherein [symbol] is the bilinear group and V_{j,l,0}, V_{j,l,1} [symbol] for j=1 to K and l=1 to L.

18. The apparatus of claim 17, wherein the first element of the first portion of the signature is determined as σ₀=g^{Σ}^{ⱼ₌₁}^{ω}^{ⱼ}^{^{K}}·Πⱼ₌₁^{K}H(\vec{V}ⱼ,M)^{r}^{ⱼ}, wherein M=M[1] . . . M[L]ε{0,1}^{L} represents the message being signed, ω₁, . . . , ω_{K} are included in the first private key, rⱼ are random integers, and H(\vec{V}ⱼ,M)=Πₗ₌₁^{L} V_{j,l,M[l]} for each jε{1, . . . , K}.

19. The apparatus of claim 17, wherein the one-time linearly homomorphic signatures are generated responsive to matrix
$${( {M}_{i , j} )}_{i , j} = ( \begin{matrix}{\vec{V}}_{1}^{T} & {Id}_{{f}_{1} , 2 L} & … & {1}^{2 L \times 2 L} & 1 & … & … & 1 \\ ⋮ & ⋱ & ⋱ & & ⋮ & ⋱ & & ⋮ \\ {\vec{V}}_{K}^{T} & {1}^{2 L \times 2 L} & … & {Id}_{{f}_{K} , 2 L} & 1 & & & ⋮ \\ g & {1}^{1 \times 2 L} & & {1}^{1 \times 2 L} & {u}_{1} & 1 & … & 1 \\ g & {1}^{1 \times 2 L} & & {1}^{1 \times 2 L} & 1 & {u}_{2} & & ⋮ \\ g & {1}^{1 \times 2 L} & & {1}^{1 \times 2 L} & ⋮ & … & ⋱ & ⋮ \\ g & {1}^{1 \times 2 L} & … & {1}^{1 \times 2 L} & 1 & … & & {u}_{K}\end{matrix} )$$
wherein Id_{f}_{ⱼ}_{,2L}=fⱼ^{I}^{_{2L}}ε [symbol] ^{2L×2L} and I_{2L} is an identity matrix in [symbol] ^{2L×2L}, p is the order of group [symbol] , and generators g, f₁, . . . , f_{K}, u₁, . . . , u_{K} [symbol] .

20. The apparatus of claim 19, wherein the one-time linearly homomorphic signatures {(Zᵢ, R_{i,1}, . . . , R_{i,K})}ᵢ₌₁^{K(2L+1)} are determined on rows \vec{M}ᵢ=M_{i,1}, . . . , M_{i,4L+2})ε [symbol] ^{K(2L+1)+1} of M=(M_{i,j})_{i,j}, using a private key skₕₛₚₛ=({χᵢ, {γ_{j,i}}ⱼ₌₁^{K}}ᵢ₌₁^{K(2L+1)+1)}, wherein χᵢ, γ_{j,i} [symbol] ₚ.

21. The apparatus of claim 20, wherein the first private key includes the private key skₕₛₚₛ for the one-time linearly homomorphic signatures.

22. An apparatus for verifying a signature of a message, comprising:
an interface configured to access the message, the signature, and a first set of public key elements, the first set of public key elements including a first set of vectors based on elements of a bilinear group and a second set of vectors based on one-time linearly homomorphic signatures, wherein at least one of the first set of vectors and the second set of vectors is generated using a probabilistic process,
wherein a first portion of the signature is determined responsive to the message, the first private key and the first set of vectors, and
wherein a second portion of the signature is determined responsive to the first private key and the one-time linearly homomorphic signatures; and
a processor configured to verify whether the signature is valid responsive to the first set of public key elements and the message.

23. The apparatus of claim 22, wherein the signature under a K-linear assumption consists of 2K+2 elements from the bilinear group, and wherein each of the first portion and the second portion of the signature corresponds to K+1 elements from the bilinear group.

24. The apparatus of claim 22 wherein K=2.
